(19) United States
(12) Patent Application Publication
(10) Pub. No.: US 2004/0064374 A1
(43) Pub. Date: Apr. 1, 2004

(54) Network-based system and method for retail distribution of customized media content

(76) Inventor: Mansoo S. Cho, Ko-Yang City (KR)

Correspondence Address: JONES DAY, 222 EAST 41ST STREET, NEW YORK, NY, 10017, US

(21) Appl. No.: 10/256,109

(22) Filed: Sep. 26, 2002

(51) Int. Cl. G06F 17/60

(52) U.S. Cl. 705/26

(57) ABSTRACT

An Internet-based system for retail distribution of customized media content is disclosed. In a first embodiment of the invention, a retail establishment provides cards representing media content available for access. A customer selects the cards they wish to own, and when finished, the retail establishment presents a cost. After payment is received, the retail establishment grants the customer access to the media content. In another embodiment of the invention, a networked server provides a distribution center for providing media content to the customer. The networked server receives data corresponding to the information contained on a card and subsequently allows access the media content.

### FIELD OF THE INVENTION

The present invention relates generally to the distribution of media content. More particularly, the present invention relates to a method and system utilizing cards, representing ownership of media, to choose, receive, and/or customize media content.

### BACKGROUND OF INVENTION

Traditional music distribution methods have forced consumers to purchase entire albums for a few desired songs and this pressure has promoted the illegal copying and distribution of songs using networked personal computers. Consumers are often upset by the need to purchase an entire music album, usually comprising collections of between seven to eighteen songs, just for one or two preferred songs. Manufacturers have created the “singles” format, comprising one or two songs, to help alleviate this problem. Overhead costs however make “singles” relatively expensive compared to songs on full-length albums. As an example, retail stores typically sell a “single” for about half the cost of an entire album. Music manufacturers only creating singles for the most popular songs further complicate the usefulness of this format. For example, if a consumer prefers an unpopular song, he has no choice but to acquire it by purchasing the entire related album.

Traditional music distribution formats also present difficulties to music media manufacturers. As mentioned, manufacturers primarily create music media in either the “single” and “album” format. In the “single” distribution format, manufacturers are faced with a dilemma as to which songs will be considered “hits” by consumers. Manufacturers therefore must guess which songs to make into “singles.” To minimize their market risk, manufacturers make only the most popular songs into singles.

In the “album” distribution format consumers and manufacturers both face dilemmas. Album compilations typically comprise of only one or two popular “hits” among a number of other songs. Consumers would prefer to have the option to buy albums containing several of their favorite songs from one or more artists and thus they must contend with less-than-satisfactory products. In addition, music media manufacturers face the prospect of reduced sales because the popular “hits” on a particular album may not provide sufficient value for a consumer to make the purchase.

Music media manufacturers have offered “Greatest Hits” albums to deal with the nuances of the “single” and “album” distribution format. These albums may contain the best songs from a particular artist, during a certain time period, in a specific genre, etc. Manufacturers however still face the difficult decision of determining which compilation of songs will result in the largest number of sales.

The problem of determining the best compilation of songs to gain the maximum return is further compounded by the present distribution process, which requires that manufacturers load the distribution pipeline with sufficient product to meet anticipated future demand. The music manufacturer faces the possibility of significant financial losses due to unsold inventory and distribution expenses if the album is not accepted by consumers.

In this seemingly unfair retail model, customers are driven to obtain desired songs illegally. Rapid developments in the PC, the Internet, and file compression have acted as a catalyst, allowing consumers to participate in this unlawful activity. As PC technology has developed, advanced features such as CD-ROM drives and CD burners have become standard equipment on most home and work computers, easily allowing illegal copying of media. Computer manufacturers provide CD-ROMs on most PCs for the purpose of easing distribution of large applications and data from vendors. Previously, the common distribution media was a 3.5″ disk capable of holding 1.4 MB of data. But as software evolved and became more complex, distribution required many such disks to distribute even the simplest applications. CDs significantly ease this distribution burden because of their large capacity (e.g. up to 640 MB of data) and thus CD-ROMs have become a necessity for modern PCs. In a more recent trend, computer manufacturers also are providing CD-burners with new PCs. The demand by home and work users for performing backups, archiving old data, making backups of software, etc. induced this change.

Consumers legitimately use both the CD-ROM and CD-burner for viewing and recording media. For example, CD-ROM/CD-burner combinations allow users to create custom music CDs from their own purchased works. However other consumers often employ the CD-ROM/CD-burner combination to illegally copy one or more songs from unowned CDs (e.g., from a friend's music collection) to a computer hard drive. Once songs are on the hard drive, users may either listen to the song(s) using a media player or write them to a CD.

Rapid developments in the Internet have also encouraged illegal copying and distribution of media. The most relevant development is the use of Napster-like file-sharing software. Media file-sharing software providers have directed their efforts into developing products that anonymously transfer music media thus circumventing copyright issues. Users employ CD-ROM drives to copy songs from a CD and file-sharing software to distribute the media to users throughout the world via the Internet. The growth of broadband connection availability is another development that promotes illegal file-sharing activity. These connection significantly improve Internet communication bandwidth and further encourage users to distribute and download media in this way.

Improvements in file compression have also played a key role in encouraging the illegal copying and distribution of copyrighted material. One of the most widely used compression formats is MP3. MP3's unique ability to significantly compress file size while retaining high-quality sound allows more rapid distribution and download and has hence become the prevailing file compression format for music. In addition, there are various free MP3 media players as well as a similar array of applications that convert between the MP3 and CD audio formats. Such applications allow a user to download illegally copied MP3 files through the Internet and listen to them on their PCs or easily convert them into customized CDs.

Online music services exist that provide various alternatives for purchasing individual songs and creating customized CDs, but they often fail to meet customer needs because of cumbersome ordering processes, slow shipping, and a high per-song cost. Services exist that sell songs in various formats (e.g., MP3) over the Internet, but to effectively use these services providers often require customers undergo a cumbersome multiple page form-based web registration process, pay via some electronic means, download the purchased media, and optionally convert the downloaded media into a CD format and write it on a CD. For an experienced and patient computer user this type of service may work fine, but for non-computer savvy users (i.e., technophobes) this process may seem tedious and complicated. For example, an online music service would not satisfy a computer-illiterate parent who would like to purchase a compilation of their child's favorite songs as a gift.

Alternatively many online music services may accept orders by telephone or fax, and then ship customized CDs to the customer. This model however provides no immediate gratification because the customer may have to wait up to two weeks for the creation and delivery of the CD. The parent seeking a gift for a child would prefer going to a store, selecting a list of their child's favorite songs, choosing a song order, and subsequently leaving with a customized CD.

Additionally, the cost of a song typically ranges between $6 to $8 when using these online music services. Relative to the cost of an entire album in a traditional retail store, the cost of a single song remains expensive. It is much simpler and cheaper (indeed, costless) to use illegal file-sharing software—a customer merely enters the name of a song or artist, reviews the results, and immediately downloads one or more songs. If the customer desires, he may still convert the downloaded songs into a CD format and write them to a CD. Although this last step may be cumbersome for some users, customers would have to perform this conversion as well when using most online music services.

Illegal copying and distribution of music reduces royalties received by the music industry, hurting both music manufacturers and recording artists who are entitled to compensation. The current retail model, which many consumers perceive to be unfair, however continues to encourage illegal copying. If on the other hand, retailers would provide an individual song format that could be easily purchased at a reasonable price (e.g., one-twelfth the cost of a CD with twelve songs), conscientious customers would be more willing to purchase media instead of obtaining it illegally. Current implemented models and prior art provide several suggestions for improving music distribution, but none furnish an adequate solution. Some insufficiencies amongst these prior suggestions include a cumbersome online ordering process that deters computer-illiterate customers, delays due to CD creation at centralized production sites and mail delivery to the customer, and a relatively high per-song cost in comparison to albums that consumers may purchase in a retail store. As a result, there exists a need for a method and system that provides a practical solution for consumers to purchase songs on an individual basis and to create personalized compilations based on individual music interests. In addition, music manufacturers need a method and system for “just-in-time” fabrication of customized media that would help save distribution and pre-loading costs and eliminate the dilemma of predicting which songs will successfully sell singles or compilation CDs.

### SUMMARY OF THE INVENTION

The present invention is an Internet-based system and method for retail distribution of customized media content that overcomes the above-described problems. In one aspect, the present invention is a method and system for distributing media content to a customer, comprising: providing, at a retail location, cards that represent media content available for online access; allowing a customer to select from the cards; presenting the customer with a cost for the cards; receiving an indication that the customer has made payment; and granting the customer access to the media content. In a preferred embodiment of the invention, a physical card is provided to a customer upon payment of the cost of the card.

In another aspect, the present invention is a method and system for distributing media content to a customer, comprising: receiving at a networked server data corresponding to the information contained on a card; and allowing the customer to access the media content. In a preferred embodiment of the invention, a physical card is provided to a customer upon payment of the cost of the card, which is sent to the customer with the CD, MD, or other forms of media encoded with music/content, or provided to the customer even if physical media is not sent to the customer, e.g., if the customer downloads the content using an invoice number/code. Such cards provide indicia of ownership.

The present invention, in contrast to other practices, encompasses allowing computer-illiterate customers to create and purchase customized media, by furnishing the purchased customized media immediately, and by providing a reasonable per-song cost.

### BRIEF DESCRIPTION OF THE FIGURES

FIG. 1 shows the main components of an Internet-based architecture for retail store distribution of customized media content;

FIG. 2 depicts the components of the online provider's system;

FIG. 3 depicts the components of a computer in a music store or a customer's home or office;

FIGS. 4.1-4.4 depict a song card suitable for use in the present invention;

FIG. 5 is a flow chart illustrating the process for a customer to create a customized music compact disk or to download customized music in a digital format;

FIGS. 6.1-6.2 is a flow chart depicting a method for a retailer and online provider to sell a song card and allow a customer to create a customized music compact disk or to download the customized music in a digital format; and

FIG. 7 illustrates a method for an online provider distributing copyright royalties.

### DETAILED DESCRIPTION OF THE INVENTION

A media supplier may provide song cards to retail locations so that customers may purchase songs on a per-song basis. An artist often releases music in the form of an album comprising of a collection of songs. In the typical music distribution model a customer must purchase the entire album as one item. In the present invention, however, a customer may purchase music on a song-by-song basis. For example, if an artist records ten songs on an album, it is considered ten individually purchasable items on the market. Each song has its own identity and may be sold individually in the form of a song card. Retail locations may stock these song cards and/or be equipped with computers capable of downloading and writing one or more songs to various formats (e.g., CD, cassette). Upon purchase, the retail location may scan identifying information on the card, received payment from the customer, and instigate automatic payment of royalties to record companies and music artists. Billboard chart sales (or any other similar ranking method) may determine the cost of a song and thus the price may change daily or weekly.

Once a customer purchases a song card, the method of providing the song may vary depending on the desired implementation. In one embodiment after paying for one or more song cards, a store employee creates a version of a customized CD with user preferences, such as song order, fade between songs, etc. In another embodiment, customers may retreat to a special section in the store where download/CD-writer equipment is available. There, customers may download songs and create a customized CD according to their purchased song cards. Alternatively in another further embodiment, a customer may download songs through the Internet (e.g., at home or office) based on the purchased cards and either store the songs on their computer hard drive (for listening by a media player) and/or create their own customized music CDs (if CD-writer equipment is available).

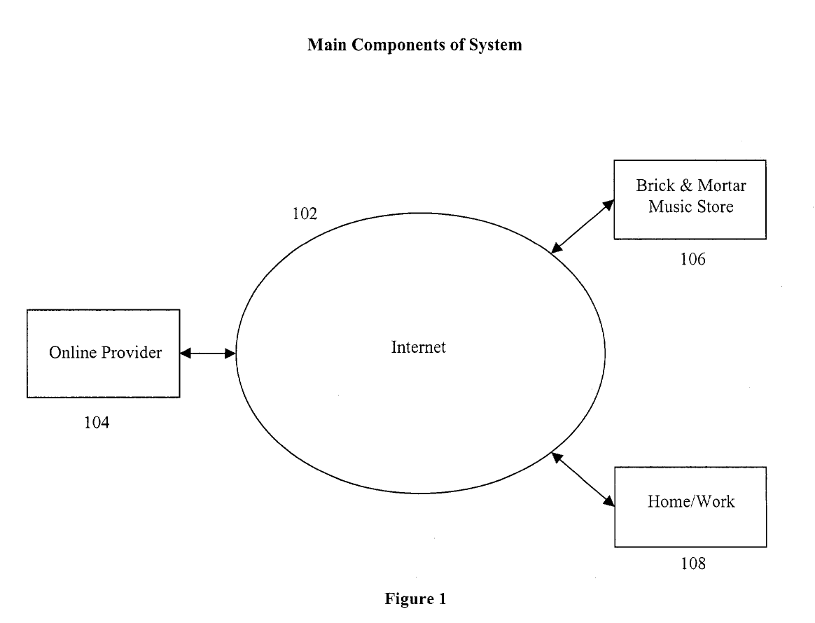

FIG. 1 shows the main components of an Internet-based system for retail distribution of customized media content in accordance with the invention. The Internet 102, or any other network, is used to connect the online provider 104, a brick & mortar music store 106, and a home or office computer 108. The online provider 102 comprises one or more networked servers that provide services for distributing media. In the preferred embodiment, media content may, for example, be recognized as music songs or any other type of content that can be stored on a recordable medium. The media may comprise of single forms of media or multiple forms of media (i.e., multimedia) recorded in an analog or digital format. In the preferred embodiment, the recordable medium may be a compact disk; however, other forms of recordable mediums may be used, for example, a cassette tape.

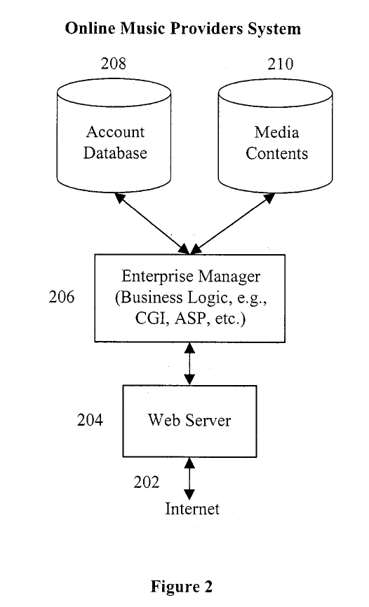

FIG. 2 depicts one embodiment of the components of the online provider system. It comprises one or more web servers 204 with a networked connection to the Internet 202, or any other such network. The web server 204 focuses on providing a front-end browser interface to retail locations and customers enabling the purchase and download of songs. An enterprise manager 206 is one or more separate servers that interface between the web server 204 and databases 208 210 and focus on providing the necessary back-end processing. This frees up the web server 204 from performing such actions. The enterprise manager 206 provides the programming logic for performing the actions related to searching for, purchasing, and downloading songs. For example, the enterprise manager 206 may query either the account or music archive databases relating to queries parsed through the web server 204. Examples of technologies used in an enterprise manager include Common Gateway Interface (CGI) and Active Server Pages (ASP). Instead of a web site designer having to create static web pages for each and every possible web page, these technologies allow the creation of a dynamic web interface via templates, databases, etc. to provide customized web pages, search capabilities, etc. The enterprise manager 206 interoperates with one or more databases, e.g., an account database 208 and a music archive 210. The account database 208 holds account profile data such as usernames, passwords, account money balance, credit card or bank information, pending purchased downloads, etc. The music archive 210 is one or more repositories that hold all songs that an online provider 104 has available for sale/download.

In a second embodiment the functions of the enterprise manager 206 may be integrated into the web server 204. In this version the web server 204 would both focus on providing the front-end browser interface and the back-end processing as previously described.

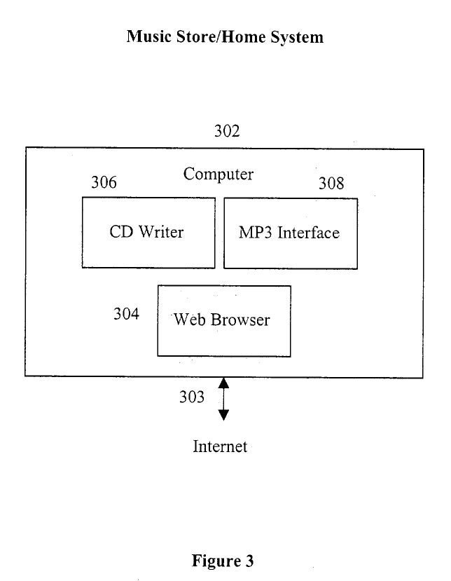

FIG. 3 details the components of a computer 302 either in a brick & mortar music store 106 or a customer's home or office 108 for purchasing and downloading music, and alternatively for writing music to a CD or for listening to music through a media player. The computer 302 may contain an Internet connection 303, a web browser 304, a CD writer 306, and/or an MP3 interface 308. Other common components of a computer may also be provided, e.g., keyboard, mouse, and monitor. A user may employ the web browser 304 to download purchased songs through the Internet connection 303. Once a customer downloads songs, he may choose to either write the songs onto a CD using the CD writer 306 or listen to the songs through the MP3 interface 308. The CD writer 306 may include several features, such as allowing the songs to be organized in a customized order, providing different types of transitions between songs, etc. The MP3 interface 308 may comprise a media player software application or may interface directly to an MP3 peripheral player device. The MP3 interface 308, media player, or peripheral player device may provide a number of features, such as allowing the songs to be organized in a customized order, providing different types of transitions between songs, etc. The downloaded songs may either be temporarily (in the case of a retail store computer) or permanently (in the case of a home or office computer) placed on the computer 302. Alternatively, the computer 302 may write the downloaded songs directly to a CD using a CD-writer 306 or a MP3 peripheral player device, with no content stored on the computer 302.

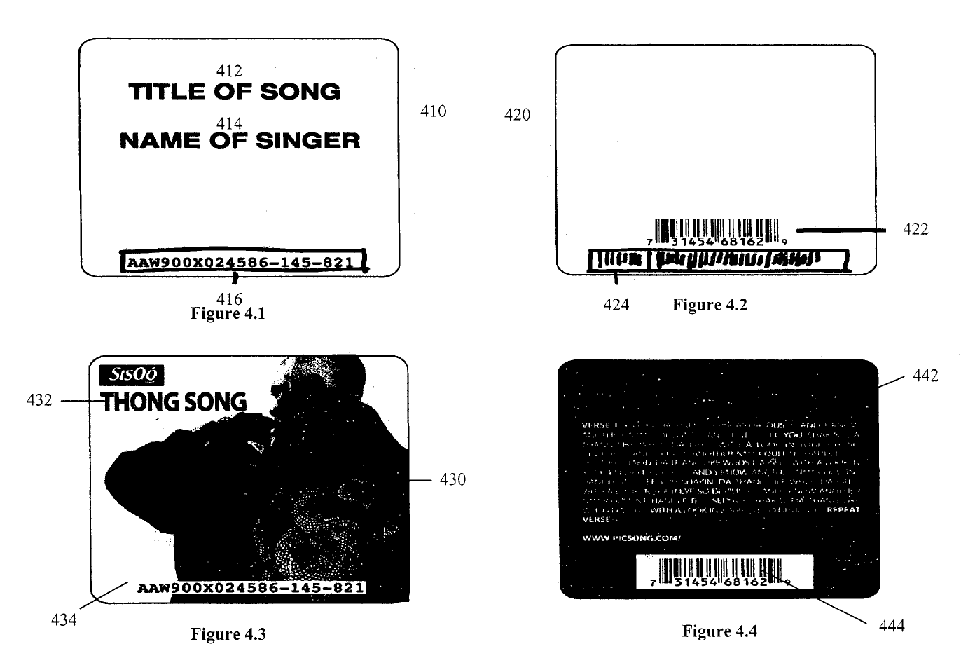

FIGS. 4.1-4.4 depict several embodiments of a card suitable for use in the present invention. Specifically, both identification and bibliographic information may be provided. Identification data, for example, may include a serial number, a bar code representing the serial number, and a UPC code. Bibliographic data may include an image of the singer, a singer's name, an album title, a song title, information about the singer, and information about the song.

FIGS. 4.1 and 4.2 show exemplary embodiments of the front and back sides of the card, respectively. The front of the card 410 may list the title of the song 412, the name of the singer 414, and a serial number 416. The back of the card 420 may show a product bar code 422 or a song bar code 424.

FIGS. 4.3 and 4.4 show an exemplary embodiment of the contents of the card 410. For example, it may contain the image or photo of the singer 430, the title of a specific song 432, a serial number 434, information about the singer or song (e.g., artist bio, song verses, etc.) 442, or a barcode 444. In addition other information that the card may contain includes the retail price of the song, digital data (e.g., barcode or magnetic strip), etc.

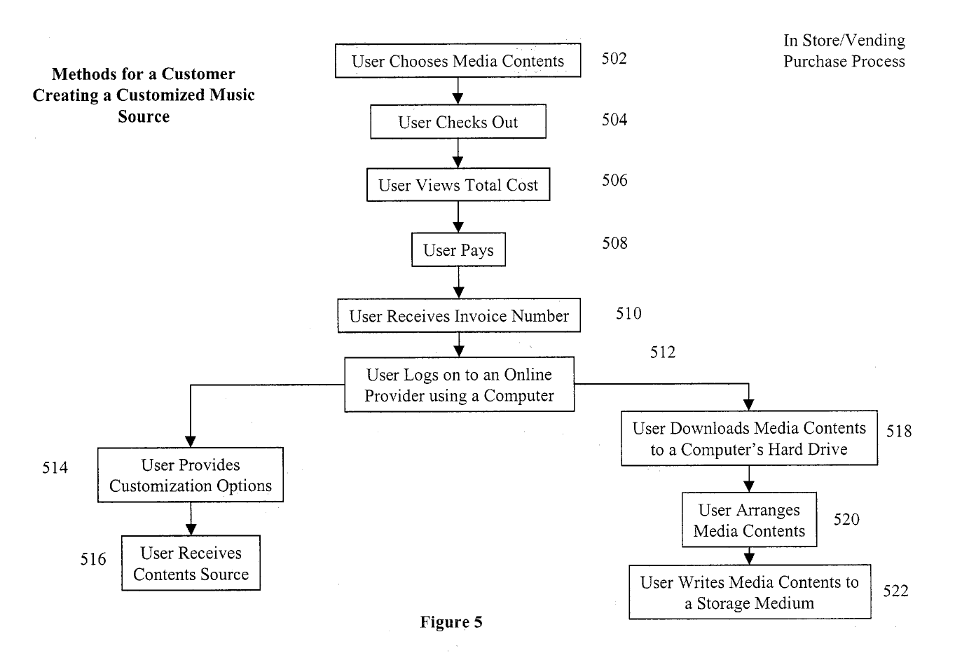

FIG. 5 is a flow chart illustrating the process for a customer to create a customized music compact disk in accordance with the present invention. First, at step 502, a customer enters a retail store or approaches a vending terminal and chooses songs to purchase by selecting the desired song cards. In one embodiment a retail store may display song cards on tables or wall racks, as how most music stores arrange CDs albums for display, and customers may individually grasp song cards. Retail stores may optionally provide a listing of available song cards and customers may request them, for example, from a store employee. In another embodiment customers may purchase song cards from a vending terminal. The vending terminal may appear and operate similar to a typical food or beverage vending machine, in which customers insert money and select a song and the vending terminal discharges a song card. The vending terminal selection process may comprise either pressing a designated button or entering a code representing a particularly listed song. Next, at step 504, the customer checks out. Checking out may be performed by bringing the cards up to a checkout counter in a retail store or selecting a button on a vending machine. At step 506, a total cost for the song cards is presented to the customer. At step 508, the-customer pays the cost. In step 510, the customer receives the song cards and an invoice number.

At step 512, the customer may either choose to have the songs burned on to a CD at a retail store or to download the songs himself. If he chooses to have a CD created in the store, the customer first logs into the online provider using a computer 512. Next, the customer may select customization options at step 514. These customization options may include, e.g., the order of the songs, and the transition between the songs. The order of the songs could also be realized by the order in which they were paid for, presented to the cashier, etc. Transitions between songs could comprise a silent pause, a melding between the end of one song and the beginning of the next song, etc. At step 516, the customer receives a customized music CD containing the desired songs according to their customized options. In another embodiment, a store employee may perform the in-store CD creation process on the customer's behalf.

Instead of creating the CD in a retail store, a customer may also choose to download the songs himself. If so, the customer may log on to the online provider from any Internet-connected computer 512 and download the songs at step 518. The download process may be accomplished using a computer with Internet access by navigating to the online provider's music distribution web site using a browser, entering a song code where specified, and downloading a song. In addition, multiple song codes may be entered at a time and all songs downloaded at once. After a customer downloads the songs, they may arrange and write them to a CD 522. In this embodiment, customers may also apply customization options as described above.

In an alternative embodiment, a customer may choose to purchase song cards online (e.g., directly at the online provider's web site or another online music store). In this embodiment the online provider or music store ships selected song cards to the customer. Customers may find this embodiment of use when purchasing one or more song cards as a gift for someone located in a different geographic region. Following a similar process at depicted in FIG. 5, a customer navigates a web browser to either the online provider's web site or an-online music store web site, searches for and selects any desired songs 502, purchases them 504, 506, 508, and additionally specifies a shipping address. Upon receiving the song cards, the gift receiver may log on to the online provider's web site 512 and download the songs over the Internet 518. Alternatively, the gift receiver may go to a participating retail location and create their own customized CDs as described above (steps 514 and 516).

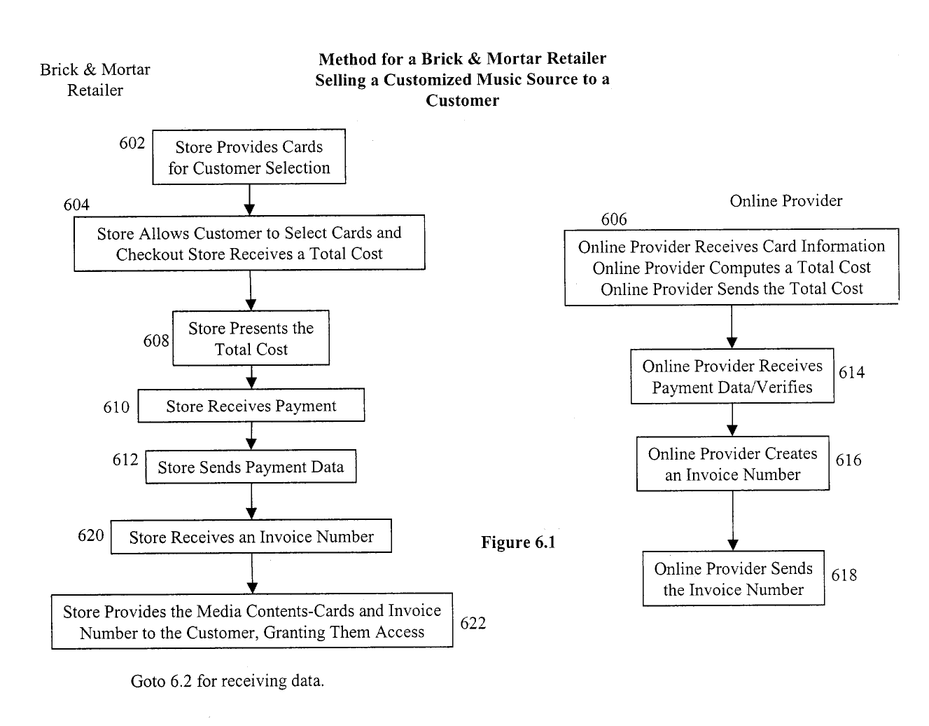

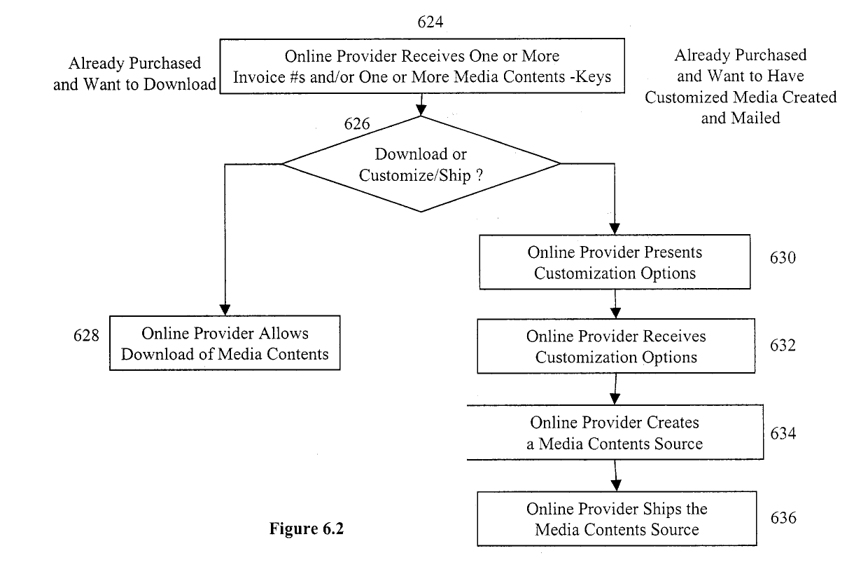

FIGS. 6.1 and 6.2 is a flow chart depicting the process for a retailer selling a card and allowing a customer to create a customized music CD. The left side of the figure illustrates the retailer's process and the right side shows the online provider's process. At step 602, the store provides one or more song cards for the customer to select. A retail store could perform this step similar to how traditional CDs are displayed in stores using tables and wall racks, or by having a list of songs to choose from with associated identification data. At step 604, the store allows a customer to select cards and checkout. Checkout comprises a store employee either receiving the song cards or the associated identification data at a checkout counter.

The store subsequently computes a total cost. The store may derive the cost of each song from a periodically updated list (e.g., each month) or obtain the cost in real-time by communicating with the online provider, e.g., via a web interface. When the store obtains the cost in real time, the online provider receives song card information, computes a total cost based on current billboard sales or other ranking information, and communicates the total cost back to the retail store 606. Alternatively, the store could also inquire for the cost of each individual song in real time and compute the total itself.

Regardless, after the store secures the total cost, at step 608, the store presents it to the customer. Next, at step 610, the store receives payment from the customer. After the receiving payment, the store sends payment data at step 612. If the customer pays with cash, the store submits payment to the online provider through its internal account, e.g., via a web interface. Each retail location establishes an internal account so that monies may be provided to the online provider if payment is in a non-electronic format. Additionally the internal accounts may be used by the online provider to pay out commissions for sales at a retail store. If payment is made with a credit card, debit card, or other electronic format, the store enters the data into the online provider system for verification and debit, e.g., through a web interface. At step 614, the online provider receives payment data and verifies it. At step 616 the online provider creates an invoice number. The online provider sends the invoice number to the store at step 618 and the store receives this invoice number 620. Following this at step 622, the store grants the song cards and invoice number to the customer.

At this point, in one embodiment, a customer may have a customized CD created in the retail location containing purchased digital media content and thereafter have the CD granted to him. In this case there may be a general processing fee for creating the CD to cover computer maintenance and blank CD costs. In one version, the customer may retreat to a computer terminal, provide one or more song-keys or an invoice number 624, chose to download 626 628, and burn the songs onto a CD themselves. In another version, the customer may request that an in-store clerk create the CD using a similar process for an additional fee. Alternatively, in step 624, the checkout computer could grant access by automatically transmitting authorization (e.g., password or invoice number) over an in-store computer network to a CD-burning computer, eliminating the need to enter song-keys (e.g., a password) or invoice numbers. Regardless, the in-store CD creation process allows the customer or clerk to arrange the songs and provide other options.

In another embodiment, the customer could choose to have a customized CD shipped at step 626. In this embodiment the online provider presents customization options at step 630 as discussed previously. At step 632 the online provider receives the customization options and at step 634 creates a music CD. Finally, the online provider delivers the CD to the customer at step 636.

In still another embodiment, the customer may use the song cards to be granted access from any Internet-connected PC to download the corresponding digital media content from the online provider as depicted by steps 624, 626, and 628. Once a customer downloads the songs, he may, for example, burn them onto a CD, listen to them on the computer using a media player, or import them to an MP3 peripheral player.

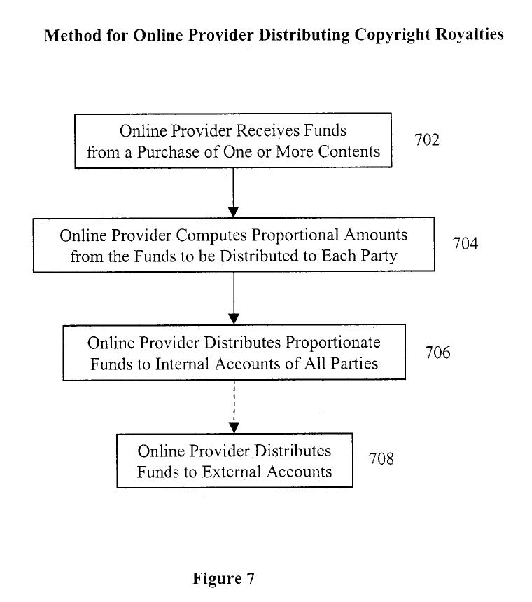

FIG. 7 illustrates a method for an online provider to distribute copyright royalties so that music companies and artists receive compensation. At step 702 an online provider receives funds from the purchase of one or more songs. A customer's credit or debit card or a retail store's internal account provides the funds. At step 704 the online provider computes the proportional amounts from the received funds to be distributed to each party (e.g., music manufacturer, artist, retail store commission, etc.). Step 706 details the online provider distributing the funds to internal accounts for each party. Internal accounts are accounts set up and managed by the online provider. Typically retail stores and music manufacturers would have internal accounts so that the online provider may easily and quickly distribute sales commissions and copyright royalties. Alternatively, individual artists may have internal accounts to receive copyright royalties as well. Finally at step 708 the online provider distributes funds to external accounts. External accounts typically represent separate accounts held at a bank on behalf of a retail store, music manufacturer, or artist. The online provider, retail store, music manufacturer, or artist may configure their internal accounts to perform distribution on a periodic basis, when the account total reaches a specified amount, or immediately, for example.

While the above invention has been described and illustrated herein with respect to certain preferred embodiments, it should be apparent that various alternatives, modifications, adaptations, and variations will be apparent to those skilled in the art and may be made utilizing the teachings of the present disclosure without departing from the scope of the invention and are intended to be within the scope of the invention as defined by the claims herein.

I claim:

1. A method for distributing online digital media content to a customer, comprising:
a. providing, at a retail location, one or more cards representing online digital media content that is available to be accessed;
b. allowing a customer to select, from the one or more cards, a card representing a selected digital media content that the customer wishes to access;
c. presenting to the customer a cost to access the selected digital media content;
d. receiving an indication that the customer has made payment corresponding to the presented cost; and
e. granting the customer access to the selected digital media content.

2. The method of claim 1, in which the step of granting comprises transferring possession of the one or more cards to said customer.

3. The method of claim 1, in which the step of granting comprises transmitting authorization to a networked computer.

4. The method of claim 3, in which the step of transmitting authorization comprises communicating one of a password or an invoice number.

5. The method of claim 1, in which the step of granting comprises supplying a customized compact disk containing the online digital media content.

6. The method of claim 1, in which the step of granting comprises downloading the online digital media content to a personal computer.

7. A method for distributing online digital media content to a customer, comprising:
a. receiving at least one datum corresponding to information contained on a card representing predetermined online digital media content that the customer is entitled to access; and
b. allowing the customer to access the predetermined online digital media content.

8. A system for distributing online digital media content to a customer, comprising:
a. one or more cards representing online digital media content that is available to be accessed; and
b. a vending terminal, configured to:
i. provide one or more cards representing online digital media content that is available to be accessed;
ii. allow a customer to select, from the one or more cards, a card representing the online digital media content that the customer wishes to access;
iii. display a cost for the customer to access the desired online digital media content;
iv. receive an indication that the customer has made payment corresponding to the displayed cost; and
v. grant the customer access to the online digital media content.

9. The system of claim 8, further comprising a card dispenser connected to said vending terminal, and wherein said vending terminal grants the customer access to said online digital media content by dispensing said selected one or more cards to said customer through said card dispenser.

10. The system of claim 9, further comprising a networked media writer, and wherein said one or more cards grants the customer access to said online digital media content by said media writer receiving one or more datum, downloading one or more media, creating a customized recorded medium, and transferring said customized recorded medium to said customer.

11. The system of claim 10, in which said one or more datum is a media password on said one or more cards or an invoice number.

12. The system of claim 8, further comprising a network interface connected to said vending terminal, and wherein said vending terminal grants the customer access to said online digital media content by transmitting one or more datum over said network interface.

13. The system of claim 12, further comprising a networked media writer connected to said network interface, and wherein said one or more datum grants the customer access to said online digital media content by said media writer receiving one or more datum, downloading one or more media, creating a customized recorded medium, and transferring said customized recorded medium to said customer.

14. The system of claim 13, in which said one or more datum is a media password on said one or more cards or an invoice number.

15. A system for distributing online digital media content to a customer, comprising:
a. one or more cards representing online digital media content that is available to be accessed; and
b. a point of service terminal, configured to:
i. receive a first indication concerning a customer selection of the desired online digital media content;
ii. display a cost for the customer to access the desired online digital media content;
iii. receive a second indication that the customer has made payment corresponding to the displayed cost; and
iv. grant the customer access to-the online digital media content.

16. The system of claim 15, further comprising a networked media writer, and wherein said one or more cards grants the customer access to said online digital media content by said media writer receiving one or more datum, downloading one or more media, creating a customized recorded medium, and transferring said customized recorded medium to said customer.

17. The system of claim 16, in which said one or more datum is a media password on said one or more cards or an invoice number.

18. The system of claim 15, further comprising a network interface connected to said point of service terminal, and wherein said point of service terminal grants the customer access to said online digital media content by transmitting one or more datum over said network interface.

19. The system of claim 18, further comprising a networked media writer connected to said network interface, and wherein said one or more datum grants the customer access to said online digital media content by said media writer receiving one or more datum, downloading one or more media, creating a customized recorded medium, and transferring said customized recorded medium to said customer.

20. The system of claim 19, in which said one or more datum is a media password on said one or more cards or an invoice number.

21. A system for distributing online digital media content to a customer, comprising:
a. a networked server, configured to:
i. receive at least one datum corresponding to information contained on a card representing predetermined online digital media content that the customer is entitled to access; and
ii. allow the customer to access the predetermined online digital media content.

22. A card for use in a customized music source system, comprising at least one identifying datum that indicates predetermined online digital media content that is available to be accessed.

23. A card of claim 22, wherein the card represents an entitlement of a person to access the predetermined online digital media content.

24. The card of claim 22 further comprising bibliographic datum.
